(19) United States
(12) Patent Application Publication
(10) Pub. No.: US 2009/0253340 A1
(43) Pub. Date: Oct. 8, 2009

(54) MULTI-FUNCTION CHEERING TOOL

(76) Inventor: Hae Jin Lee, Seoul (KR)

Correspondence Address: HARNESS, DICKEY, & PIERCE, P.L.C, 7700 Bonhomme, Suite 400, ST. LOUIS, MO, 63105, US

(21) Appl. No.: 12/304,145

(22) PCT Filed: Nov. 6, 2006
(86) PCT No.: PCT/KR2006/004608

§ 371 Date: Dec. 10, 2008

(30) Foreign Application Priority Data
Jun. 12, 2006 (KR) 20-2006-0015736

(51) Int. Cl. A63H 5/00; G10D 15/00

(52) U.S. Cl. 446/81; 446/421

(57) ABSTRACT

The present invention proposes a multi-function cheering tool, more particularly, a multi-function cheering tool for both promoting sports players' morale and spectators' cheering participation by developing a number of cheerful cheering practices according to the needs of cheering events in combination with bugle, megaphone and plastic bar. The multi-function cheering tool comprises a hollow cone type plastic tube, a bugle, a hitting bar, and a grip. One end of the hitting bar is fixed to an inner side of the grip and the other end of the hitting bar is expanding toward the hollow cone type plastic tube inwardly. And, the grip is formed in a hollow cylinder type in order to combine the hollow cone type plastic tube and the bugle, and functions as a megaphone in combining with the hitting bar.

### TECHNICAL FIELD

The present invention relates to multi-function cheering tool, more particularly, to multi-function cheering tool for both promoting sports players' morale and spectators' cheering participation by developing a number of cheerful cheering practices according to the needs of cheering events in combination with bugle, megaphone and plastic bar.

### BACKGROUND ART

Conventionally, there are many cheering tools, such as bugle, clapper, pipe, megaphone, balloon sticks and flags, etc. And, these cheering tools are used independently according to its function. However, several combined cheering tools have recently appeared.

However, most of the conventional cheering tools are disposable products, and the events place has been messed-up around after finishing the events, since they are not made of firm materials.

In the meantime, since the 2002 world cup, many of spectators have been getting together, accordingly, there are lots of big cheerings inducing one voice for a sense of unity. Therefore, the cheering spectators have to shout up. Accordingly, megaphone is necessary for assisting the big and loud voice as a cheering tool. Moreover, a combined multi-function cheering tool with a megaphone being easily portable and convenient for use and other independent cheering tools is needed more.

### DISCLOSURE OF INVENTION

### Technical Solution

According to a preferred embodiment of the present invention for achieving an objective as described above is characterized that in a multi-function cheering tool comprising a hollow cone typed plastic hitting tube, a hitting bar, a bugle and a grip, one end of the hitting bar is fixed to an inner side of the grip and the other end of the hitting bar is expanding toward the hitting tube inwardly, and the grip is formed in a hollow cylinder type in order to combine the hollow cone typed plastic hitting tube and the bugle, and functions as a megaphone in combining with the hitting tube.

According to another embodiment of the present invention, it provides a multi-function cheering tool in which one end side of the bugle has a rectangular shape for readily blowing while contacting lips, and the other side of the buggle has a round shape for easy combining with the grip.

According to still another embodiment of the present invention, it provides a multi-cheering tool in which an opening unit of the grip to be connected to the bugle is formed in round shape for completely covering lips and effectively collecting sounds.

### BRIEF DESCRIPTION OF THE DRAWINGS

The above and other features and advantages of the present invention will become more apparent by describing in detailed example embodiments thereof with reference to the accompanying figures, in which:

FIG. 1 is a perspective view of a multi-function cheering tool according to a preferred embodiment of the present invention.

FIG. 2 is a front view of a multi-function cheering tool according to a preferred embodiment of the present invention.

FIG. 3 is a disassembled front view of a multi-function cheering tool according to a preferred embodiment of the present invention.

### BEST MODE FOR CARRYING OUT THE INVENTION

The present invention is described more fully hereinafter. The present invention may, however, be embodied in many different forms and should not be construed as limited to the embodiments set forth herein. Rather, these embodiments are provided so that this disclosure will be thorough and complete, and will fully convey the scope of the present invention to those skilled in the art.

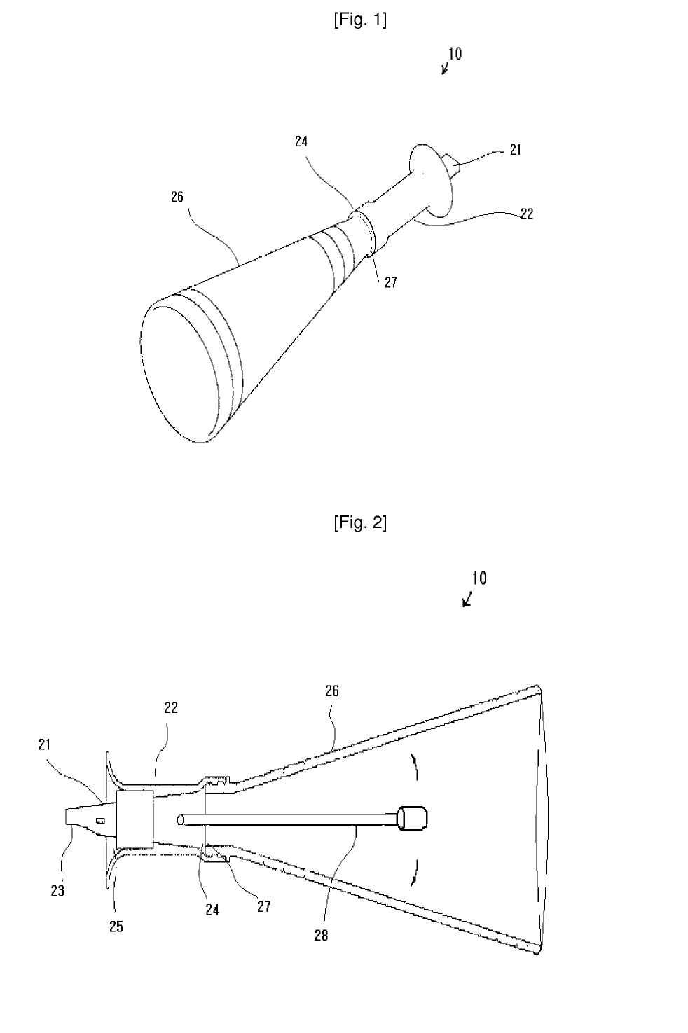

FIG. 1 is a perspective view of a multi-function cheering tool according to a preferred embodiment of the present invention.

FIG. 2 is a front view of a multi-function cheering tool according to a preferred embodiment of the present invention.

The FIGS. 1 and 2, are illustrated a multi-function cheering tool according to a preferred embodiment of the present invention.

Referring to FIGS. 1 and 2, the cheering tool 10 according to a preferred embodiment of the present invention is configured to a bugle 21 to either connect or disconnect to a grip 22 for easy fixing/unfixing of the bugle 21 in order to provide a variety of functions of cheering.

One end side of the bugle 21 has a flat rectangular shape for making a mouthpiece 23 convenient, and the other a round shape for easy connection to a grip 22. The bugle 21 may enable its whole function even though it is unfixed, and make a louder bugle sound so as to amplify the bugle sound while being fixed into.

Moreover, the grip 22, having a top opening unit 24 and a lower opening unit 25, is formed in a cylinder type in order to provide a convenience of the grip. The top opening unit 24 of the grip 22 is connected to an opening unit 27 of the hitting tube 26, and the lower opening unit 25 of the grip 22 to the bugle 21.

Especially, the lower opening unit 25 of the grip 22 is formed in a round shape in order to completely cover lips making sounds in comparison with the top opening unit 24 of the grip 22 for functioning as a speaking section of megaphone. In the meantime, one end side of the hitting bar 28 is fixed to an inner side of the grip 22, and the other end side of the hitting bar 28 is expanding toward the hitting tube 27 inwardly.

Especially, one end of the hitting bar 28 disposed to the inner side of the hitting tube 27 has a small cylinder shape so as to make a hitting sound effectively when hitting the hitting tube 27.

At cheering for hitting sounds, they may shake the hitting tube 26 while holding the grip 22, or bump against the other palm of the hand so that the hitting bar 28 is shaken and hits the hitting tube 27, resulting in making hitting sounds.

A logo of the team for cheering may be used on the surface of the hitting tube 26 so that the cheering effect may be much improved and provide a variety of visual effects to silent spectators.

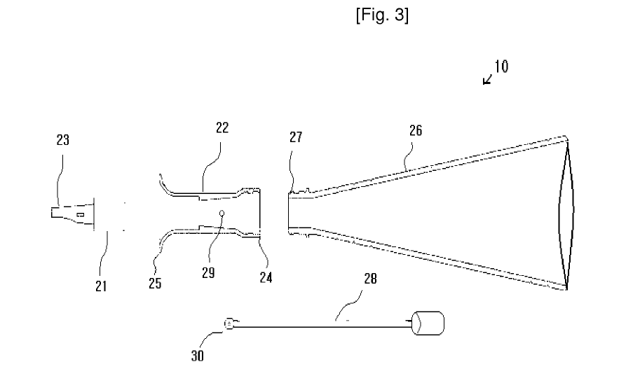

FIG. 3 is a disassembled front view of a multi-function cheering tool according to a preferred embodiment of the present invention.

Referring to FIG. 3, the multi-function cheering tool according to the present invention may be disassembled into a bugle 21, a grip 22, a hitting bar 28 and a hitting tube 26 with easiness, and a pin hanger 30 of the hitting bar 28 is fixed to a fixing pin 29 disposed inwardly to the grip 22 so that it may not separate while shaking the tube 26 severely.

Although a few example embodiments of the present invention have been described, those skilled in the art will readily appreciate that many modifications are possible in the example embodiments without materially departing from the novel teachings and advantages of the present invention. Accordingly, all such modifications are intended to be included within the scope of the present invention as defined in the claims. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The present invention is defined by the following claims, with equivalents of the claims to be included therein.

### INDUSTRIAL APPLICABILITY

As aforementioned, the multi-function cheering tool according to the present invention has various effects of bugle, megaphone and drum at places such as campaign or concerts which a lot of spectators get together. Therefore it may attract public gazes and promote cheering mood and it could may create a new cheering culture.

1. A multi-function cheering tool comprising:
a hollow cone type plastic hitting tube;
a hitting bar;
a bugle; and,
a grip, wherein one end side of the hitting bar is fixed to an inner side of the grip and the other side of the hitting bar is expanding toward the hitting tube inwardly, and
wherein the grip is formed in a hollow cylinder type in order to combine the hollow cone type plastic hitting tube and the bugle, and functions as a megaphone in combining with the hollow cone type plastic hitting tube.

2. A multi-function cheering tool of the claim 1, wherein one end of the bugle has a rectangular shape for readily blowing while contacting lips, and the other side of the bugle has a round shape for easy combining with the grip.

3. A multi-function cheering tool of the claim 1, wherein an opening unit of the grip to be connected to the bugle is formed in round shape for completely covering lips and effectively collecting sounds.

4. A multi-function cheering tool comprising:
a plastic hitting tube;
a bugle; and
a grip, wherein the grip is formed in a hollow cylinder type in order to combine the plastic hitting tube and the bugle, and functions as a megaphone in combining with the hitting tube.

5. A multi-function cheering tool of the claim 4, wherein the plastic hitting tube is a hollow cone type.

6. A multi-function cheering tool of the claim 4, further comprising a hitting bar wherein one end side of the hitting bar is fixed to an inner side of the grip and the other side of the hitting bar is expanding toward the hitting tube inwardly.
